(19) United States
(12) Patent Application Publication
(10) Pub. No.: US 2024/0075408 A1
(43) Pub. Date: Mar. 7, 2024

(54) SIMULTANEOUS QUANTIFICATION OF ANIONS USING ION CHROMATOGRAPHY AND SUPPRESSED ION CONDUCTIVITY DETECTION

(71) Applicant: Arizona Board of Regents on Behalf of Arizona State University, Scottsdale, AZ (US)

(72) Inventors: Rosa Krajmalnik-Brown, Chandler, AZ (US); Srivatsan Mohana Rangan, Tempe, AZ (US); Devin Bowes, Tempe, AZ (US)

(21) Appl. No.: 18/456,090

(22) Filed: Aug. 25, 2023

Related U.S. Application Data
(60) Provisional application No. 63/401,407, filed on Aug. 26, 2022.

(51) Int. Cl. B01D 15/36

(52) U.S. Cl. CPC B01D 15/363

(57) ABSTRACT

Methods and systems for the detection and quantification of multiplicity of ionic analytes comprising bromide, phosphate, sulfite, thiosulfate, thiocyanate, and formate, and optionally fluoride, chloride, chromate, selenate, perchlorate, nitrate, nitrite, and sulfate, using ion chromatography and suppressed ion conductivity. The method comprises loading a sample loop with a sample; injecting the sample from the sample loop into a column with an eluent, wherein the column comprises a guard column and an analytical column; separating, with the column, the injected sample at an effective separation temperature the injected sample in the presence of an organic modifier into a multiplicity of detectable ionic analytes; suppressing, with a suppressor, background signal; and detecting, with a detector, the multiplicity of ionic analytes.

### CROSS-REFERENCE TO RELATED APPLICATIONS

The present application claims benefit of priority to U.S. Provisional Patent Application No. 63/401,407, filed Aug. 26, 2022, the content of which is hereby incorporated by reference in its entirety.

### STATEMENT REGARDING FEDERALLY SPONSORED RESEARCH

This invention was made with government support under 1449501 awarded by the National Science Foundation. The government has certain rights in the invention.

### FIELD OF THE INVENTION

The disclosed technology is generally directed to ion chromatography. More particularly, the technology is directed to simultaneous quantification of various anions pertaining to human health and environmental health.

### BACKGROUND OF THE INVENTION

Anions are of high importance in human health, environmental, and industrial applications. In our ecosystem, anions play a vital role in environmental cycling of elements and human metabolism. Ion chromatography with suppressed conductivity detection is commonly used by laboratories, industries, and environmental practitioners to quantify anions. However, quantifying multiple anions from aqueous matrices for a diverse range of applications typically requires multiple analytical methods with modifications in the instrumentation, stationary phase (analytical separation column), and/or mobile phase (eluent) composition. The tedious sample preparation techniques, complex instrumentation, and large sample volumes required to quantify a diverse range of anions using known quantification techniques increases both the time and the cost for the analysis. Thus, there remains a need for efficient methods for quantifying multiple anions in a sample with improved sensitivity and reduced cost. In particular, there is an unmet need for methods capable of quantifying multiple anion species simultaneously (e.g., from a single loaded sample) to avoid complex analytical processes.

### BRIEF SUMMARY OF THE INVENTION

Disclosed herein is an isocratic ion chromatography (IC) analytical method with suppressed conductivity detection for simultaneous quantification of various anions. The method comprises loading a sample loop with an aqueous sample, injecting the sample from the sample loop into a column with an eluent, wherein the column comprises a guard column and an analytical column, separating, with the column, the injected sample at an effective separation temperature in the presence of an organic modifier into a multiplicity of detectable ionic analytes comprising bromide, phosphate, sulfite, thiosulfate, thiocyanate, and formate, suppressing, with a suppressor, background signal, and detecting, with a detector, the multiplicity of ionic analytes.

Another aspect of the invention comprises a system for simultaneous quantification of anions. The system comprises an eluent, an organic modifier, an injector, a column, the column comprising a guard column and an analytical column, a suppressor, and a detector, wherein the system is configured for detection of a multiplicity of ionic analytes comprising bromide, phosphate, sulfite, thiosulfate, thiocyanate, and formate.

In some embodiments, the methods and systems are configured for simultaneous detection of bromide, phosphate, sulfite, thiosulfate, thiocyanate, formate, fluoride, chloride, chromate, selenate, perchlorate, nitrate, nitrite, and sulfate.

In some embodiments, the methods and systems disclosed herein can be used to quantify various anions (e.g., up to 14 anions) simultaneously in a short period of time (e.g., less than 35 minutes), while needing only a small volume (e.g., 100 μL) of aqueous sample. Advantageously, simultaneous quantification of multiple anions decreases the time, sample volume, and cost for analyses compared to using multiple methods for quantification of specific anions.

In yet another aspect, the present disclosure provides method for chromatographic quantification of anions, the method comprising: injecting a single sample comprising a plurality of anions into a column; separating the plurality of anions in the single sample by chromatography using a mobile phase comprising sodium bicarbonate and an organic modifier, whereby the plurality of anions are eluted by the mobile phase from the column; and quantifying each of the plurality of anions eluted from the column.

Additionally, the present methods and systems can be used with diverse aqueous matrices, including samples of human origin, such as plasma, blood, and urine.

### BRIEF DESCRIPTION OF THE DRAWINGS

FIG. 1 shows a representative chromatogram of 14 anions in water at 1 mg/L concentration.

FIG. 2 shows a representative chromatogram of drinking water (reverse-osmosis) sample spiked with 200 μg/L anions.

FIG. 3 shows a representative chromatogram of groundwater (Goodyear, AZ) sample spiked with 200 μg/L anions.

FIG. 4 shows a representative chromatogram of surface water (Tamilnadu, India) sample spiked with 200 μg/L anions.

FIG. 5 shows a representative chromatogram of wastewater (Water reclamation plant, Mesa, AZ) sample spiked with 200 μg/L anions.

FIG. 6 shows a representative chromatogram of urine sample spiked with 200 μg/L anions.

### DETAILED DESCRIPTION OF THE INVENTION

Issues concerning environmental and human health are often dynamic and multifaceted. They require rapid and comprehensive methods for data acquisition to inform subsequent strategical and/or diagnostic approaches. Use of a method, such as a method of the present disclosure, provide an all-encompassing suite of information in a single run since they can detect multiple anions at once.

Such methods can help determine current human health status, hold significant promise to support a rapid diagnostic protocol, and can serve to reallocate efforts where most needed. Such methods are particularly useful when attempting to assess or diagnose a disease with a complex etiology, such as neurodegenerative disorders, or to answer other complex, real-world problems, such as monitoring emerging chemicals of concern in the environment or interactions within the human gut microbiome.

Disclosed herein is an isocratic ion chromatography (IC) analytical method with suppressed conductivity detection that allows for the simultaneous quantification of various anion analytes that can be applied to a diverse range of human, industrial, and environmental issues. The developed method is relatively simple to perform, cost-effective, and can be used for quantification of anions including: common inorganic anions (e.g., chloride, fluoride, nitrite, bromide, nitrate, and phosphate), anionic sulfur species (e.g., sulfite, sulfate, and thiosulfate), toxic anions of environmental and human concern (e.g., selenate, chromate, thiocyanate, and perchlorate), as well as an organic anion (formate). The method was validated by determining the precision and accuracy for all the anion analytes in environmental aqueous matrices as well as matrices of human origin (such as urine, feces, blood, and blood plasma).

The analytical methods disclosed herein can be useful to a very wide range of professionals including, but not limited to, environmental engineers, public health practitioners, medical professionals, and community stakeholders. Possible applications include monitoring ions in environmental aqueous matrices (e.g., groundwater, surface water, and wastewater) as well as in urine, feces, and blood (whole and plasma) from both humans and animals.

In one aspect, the present disclosure provides a method for simultaneous quantification of anions, the method comprising
loading a sample loop with an aqueous sample;
injecting the sample from the sample loop into a column with an eluent, wherein the column comprises a guard column and an analytical column;
separating, with the column, the injected sample at an effective separation temperature in the presence of an organic modifier into a multiplicity of detectable ionic analytes comprising bromide, phosphate, sulfite, thiosulfate, thiocyanate, and formate;
suppressing, with a suppressor, background signal; and
detecting, with a detector, the multiplicity of ionic analytes.

In some embodiments, the multiplicity of detectable ionic analytes includes bromide, phosphate, sulfite, thiosulfate, thiocyanate, formate, fluoride, chloride, chromate, selenate, perchlorate, nitrate, nitrite, and sulfate, and the detectable ionic analytes are simultaneously detected.

The present technology allows for bromide, phosphate, sulfite, thiosulfate, thiocyanate, formate, fluoride, chloride, chromate, selenate, perchlorate, nitrate, nitrite, and sulfate to be measured in a low μg L⁻¹ concentration range without pre-treatment of the sample or post column derivatization. The ability to measure ionic analytes may be characterized by one or more of the following relationships. Resolution of two peaks (R), defined as the ratio of the difference in retention times between two peaks and the average baseline width of two peaks, may be determined using Equation 1:

$$R = \frac{{T}_{R 2} - {T}_{R 1}}{( {w}_{b 1} + {w}_{b 2} ) / 2} \qquad ( Equation 1 )$$

where T_{R1} and T_{R2} are the retention times of adjacent peaks (analyte 1 elutes before analyte 2) and w_{b1} and w_{b2} are the widths of the peaks at baseline.

The limit of detection (LOD), defined as the smallest concentration of analyte in a sample that can be readily distinguished from zero, may be determined using Equation 2:

$$L O D = \frac{3 {S}_{a}}{b} \qquad ( Equation 2 )$$

The limit of quantification (LOQ), defined as the smallest concentration of analyte in a sample that can be quantitatively determined with suitable precision and accuracy, may be determined using Equation 3:

$$L O Q = \frac{10 {S}_{a}}{b} \qquad ( Equation 3 )$$

In Equations 2 and 3, Sₐ is the standard deviation of the response estimated by the standard error of y-intercepts of the regression lines and b is the slope of the calibration curve. Accuracy, defined as the closeness between a measured value and either a true or accepted value, was evaluated by determining the precision and trueness of each analyte. The precision and trueness may be determined by calculating the relative standard deviation (RSD) and the recovery using Equations 4 and 5, respectively:

$$R S D ( \% ) = \frac{Standard deviation of measured concentrations}{A v erage of measured concentrations ( {μgL}^{- 1} )} \times 100 \qquad ( Equation 4 )$$

$$Recovery ( \% ) = \frac{Average of measured concentrations ( {μgL}^{- 1} )}{S piked concentration ( {μgL}^{- 1} )} \times 100 \qquad ( Equation 5 )$$

As used herein, a “low μg L⁻¹ concentration range” refers to a LOD less than 30.0 μg L⁻¹ and LOQ less than 100.0 μg L⁻¹. In some embodiments, the LOD is less than 8.0, 6.0, 4.0, 3.0, 2.5, 2.0, 1.8, 1.6, 1.4, 1.2, or 1.0 μg L⁻¹, depending on the analyte of interest. In some embodiments, the LOD is less than 25.0, 20.0, 18.0, 15.0, 12.0, 10.0, 8.0, 7.0, 5.0, 4.0, or 3.0 μg L⁻¹, depending on the analyte of interest. In some embodiments, the limit of detection (LOD) of the multiplicity of detectable ionic analytes is in a range between 0.1 and 30.0 μg L⁻¹, such as between 0.2 and 30.0 μg L⁻¹, between 0.5 and 30.0 μg L⁻¹, between 0.8 and 30.0 μg L⁻¹, or between 0.8 and 25.0 μL⁻¹. In some embodiments, the limit of detection (LOD) of the multiplicity of detectable ionic analytes is in a range between 0.8 and 27.6 μg L⁻¹.

The standard IC method for quantification of Cr (VI) in water samples is EPA Method 218.7, which requires post column derivatization with 1,5-diphenylcarbazide and UV-Vis spectroscopy detection. Method 218.7 is Cr (VI)-specific; thus, it does not allow detection of co-occurring natural and anthropogenic anions in environmental media.

In contrast to the EPA methodology, an isocratic IC method with suppressed conductivity detection is disclosed. As demonstrated in the Examples that follow, the present method may utilize a Metrohm Metrosep A Supp 5 column, and sodium carbonate, sodium bicarbonate, acetone, and methanol as mobile phase for simultaneous quantification of bromide, phosphate, sulfite, thiosulfate, thiocyanate, and formate. Each of these analytes may be detected in a low μg L⁻¹ concentration range. The method also advantageously allows for simultaneous quantification of bromide, phosphate, sulfite, thiosulfate, thiocyanate, formate, fluoride, chloride, chromate, selenate, perchlorate, nitrate, nitrite, and sulfate in a low μg L⁻¹ concentration range. “Simultaneous” means that the presence or concentration of two or more analytes may be qualitatively or quantitatively determined with a single analytical method using the same column and eluent in a single run. As a non-limiting example, a single sample is analyzed by the present method in a single chromatographic process (a single run), in which a plurality of anion species are eluted from a column and are then analyzed or quantified by a detector (e.g., a conductivity detector). The anion species may be eluted from the column at different elution times and a chromatograph can be recorded as each of the eluted anion species are detected by the detector as a quantifiable signal (e.g., a peak). From the chromatograph, the amount of the anion species in the sample can be determined individually. In particular embodiments, each of the anion species of interest can be quantified simultaneously from the same chromatograph generated from a single run of the chromatographic process.

The method showed good accuracy (precision and trueness) in quantification of each analyte. The disclosed technology will prove useful to environmental practitioners, academic and research organizations, and industries for monitoring low concentrations of (multiple) relevant and common anions in environmental and human origin media, helping to decrease the sample (volume) requirement, time, and cost for analysis.

Ion chromatography is a method for separating ions based upon their interactions with a stationary phase, such as a resin, and the eluent (mobile phase). Ions will move through columns packed with a stationary phase at different speeds depending on their affinity for the stationary phase, and they will separate from each other based upon differences in ion charge and size. As the eluent passes through the column, ions with a weaker affinity for the resin will move through the column faster and be eluted first, while ions with a stronger affinity for the column will move through the column more slowly.

Upon exiting the column, the ions can be measured by a detector (e.g., an electrical conductivity detector). This detector produces a chromatogram which plots conductivity vs. time. Each ion produces a peak on this graph, the area of which is dependent on the relative ion concentration in the injected solution. These measurements can then be used to determine concentrations of analytes in an unknown sample. To combat possible interference caused by the ions in the mobile phase, a suppressor may be used to remove the unwanted electrolyte prior to the conductivity measurement. As the solution passes through the suppressor, ions in the eluent are replaced with a nonionic species. Alternatively, if the eluent is sufficiently dilute or has a low conductivity, the use of a suppressor is not necessary.

In another aspect, the present disclosure provides a method for chromatographic quantification of anions, the method comprising:
injecting a single sample comprising a plurality of anions into a column;
separating the plurality of anions in the single sample by chromatography using a mobile phase comprising sodium bicarbonate and an organic modifier, whereby the plurality of anions are eluted by the mobile phase from the column; and
quantifying each of the plurality of anions eluted from the column.

In some embodiments, the mobile phase further comprises sodium carbonate. In some embodiments, the organic modifier comprises acetone, methanol, or a combination thereof.

In some embodiments, the plurality of anions comprise bromide, phosphate, sulfite, thiosulfate, thiocyanate, formate, or a combination thereof. In some embodiments, the plurality of anions further comprise fluoride, chloride, chromate, selenate, perchlorate, nitrate, nitrite, sulfate, or a combination thereof.

In some embodiments, the single sample has a volume of less than 500 μL. For example, the volume can be less than 400 μL, less than 300 μL, less than 200 μL, less than 200 μL, or less than 50 μL. In some embodiments, the single sample has a volume of about 50 μL, about 100 μL, about 150 μL, about 200 μL, about 250 μL, about 300 μL, about 350 μL, about 400 μL, or about 450 μL.

In some embodiments, the sample is obtained from a human.

In some embodiments, the method comprises quantifying each of the plurality of anions eluted from the column using a conductivity detector. In some embodiments, the method further comprises suppressing a background signal prior to quantifying each of the plurality of anions eluted from the column. In some embodiments, the method comprises suppressing the background signal using a chemical suppressor and a CO₂ suppressor.

Ion chromatography or devices for preforming the present methods may comprise a sample loop, injector, column, including guard column and analytical column, suppressor, conductivity detector, data acquisition, storage, or processing device.

In another aspect, the present disclosure provides a system for simultaneous quantification of anions, the system comprising
an eluent;
an organic modifier;
an injector;
a column, the column comprising a guard column and an analytical column;
a suppressor; and
a detector,
   wherein the injector is configured to inject an aqueous sample from a sample loop into the column with the eluent, the column is configured to separate the injected sample in the presence of the organic modifier into a multiplicity of detectable ionic analytes comprising bromide, phosphate, sulfite, thiosulfate, thiocyanate, and formate at an effective separation temperature, the suppressor is configured to suppress a background signal, and the detector is configured for detection of the multiplicity of ionic analytes.

In some embodiments, the system is configured for simultaneous detection of bromide, phosphate, sulfite, thiosulfate, thiocyanate, formate, fluoride, chloride, chromate, selenate, perchlorate, nitrate, nitrite, and sulfate.

In some embodiments, the sample from the sample loop comprises a human origin sample or an environmental sample. In some embodiments, the human origin sample comprises urine, feces, blood, or blood plasma.

In some embodiments, the organic modifier for the present system comprises acetone and methanol.

In some embodiments, the eluent for the present system comprises sodium carbonate and sodium bicarbonate.

In some embodiments, the volume of the sample from the sample loop is less than 500 μL. For example, the volume of the sample can be less than 400 μL, less than 300 μL, less than 200 μL, less than 200 μL, or less than 50 μL. In some embodiments, the volume of the sample is about 50 μL, about 100 μL, about 150 μL, about 200 μL, about 250 μL, about 300 μL, about 350 μL, about 400 μL, or about 450 μL.

In some embodiments, the suppressor for the present system comprises a chemical suppressor and a CO₂ suppressor and the detector is a conductivity detector.

In some embodiments, the eluent of the present system comprises sodium carbonate and sodium bicarbonate, the organic modifier of the present system comprises acetone and methanol, and the system is configured for simultaneous detection of bromide, phosphate, sulfite, thiosulfate, thiocyanate, formate, fluoride, chloride, chromate, selenate, perchlorate, nitrate, nitrite, and sulfate.

In some embodiments, the limit of detection (LOD) of the multiplicity of ionic analytes measured by the present system is in a range between 0.1 and 30.0 μg L⁻¹, such as between 0.2 and 30.0 μg L⁻¹, between 0.5 and 30.0 μg L⁻¹, between 0.8 and 30.0 μg L⁻¹, or between 0.8 and 25.0 μg L⁻¹. In some embodiments, the limit of detection (LOD) of the multiplicity of detectable ionic analytes measured by the present system is in a range between 0.8 and 27.6 μg L⁻¹.

As used herein, “eluent” or “mobile phase” means the medium that transports the sample through the system and contributes to the selectivity of the separation. The eluent may comprise a solution of one or more salts in water that may act as a buffer, providing a stable pH. The ion strength, pH, temperature, flow rate, and buffer salt may individually, or collectively, influence the selectivity of the separation. The eluent may also comprise an organic modifier. The present technology may utilize an isocratic methodology. “Isocratic” means that the eluent or mobile phase has a constant concentration of buffer and/or organic modifier throughout the chromatographic process.

In some embodiments, the eluent comprises a carbonate. In particular embodiments, the eluent comprises sodium carbonate and sodium bicarbonate. In some embodiments, the eluent comprises between 2.5 and 4.5 (or between 3.0 and 4.0) mM sodium carbonate and between 3.0 and 5.0 (or between 3.5 and 4.5) mM sodium bicarbonate. The eluent can comprise about 3.0, about 3.2, about 3.4, about 3.6, about 3.8, or about 4.0 mM sodium carbonate. The eluent can comprise about 3.6, about 3.8, about 4.0, about 4.2, or about 4.4 mM sodium bicarbonate. In some embodiments, the eluent comprises about 3.6 mM sodium carbonate and about 4.0 mM sodium bicarbonate.

In some embodiments, the eluent or mobile phase comprises an organic modifier. An “organic modifier” means an organic substance that may change in hydrophobic interactions between the analyte and the stationary phase; influence on ion solvation; and/or change in the Coulombic interactions between the analyte and the stationary phase. Suitably, the organic modifier may be included with eluent. In other embodiments, the organic modifier may be present in the column independent of the eluent. Exemplary organic modifiers include, but are not limited to, acetonitrile, acetone, and methanol. In some embodiments, the organic modifier comprises acetone, methanol, or a combination thereof. In some embodiments, the organic modifier comprises acetone and methanol. In some embodiments, the eluent comprises between 5% and 20% or between 10% and 18% (v v⁻¹) of the organic modifier. For example, the eluent can comprise about 4%, about 6%, about 8%, about 10%, or about 12% (v v⁻¹) of acetone. The eluent can comprise about 2%, about 3%, about 4%, about 5% about 6%, about 7%, about 8%, or about 10% (v v⁻¹) of methanol. In the examples, the eluent comprises about 8% (v v⁻¹) of acetone and about 5% (v v⁻¹) methanol.

In some embodiments, the eluent comprises sodium carbonate and sodium bicarbonate, the organic modifier comprises acetone and methanol, and the multiplicity of detectable ionic analytes comprises bromide, phosphate, sulfite, thiosulfate, thiocyanate, formate, fluoride, chloride, chromate, selenate, perchlorate, nitrate, nitrite, and sulfate, and the multiplicity of detectable ionic analytes are simultaneously detected.

“Injector” means a device for the introduction of a sample volume into the column. In the load position, a sample loop can be filled with the sample solution and, optionally, the eluent may be bypassed to the column. When the injector is turned to the inject position, the eluent can pass through the sample loop and transfer the sample to the column. By varying the sample loop volume, the amount of sample introduced may be varied.

“Column” or “chromatographic column” is a device for separating sample ions, as the term is understood in the art. The column may be packed with a stationary phase material comprising charged functional groups, or ion exchange groups, that allow for the sample ions to be separated. The column may be characterized by its capacity, selectivity, and efficiency. Capacity is determined by the column's ability to attract ions and the eluent strength required to elute these through the column. Selectivity is the column's ability to separate different analytes and is affected by the chemical and physical qualities of the column that results in interaction with the ions to be separated and the choice of eluent. Efficiency is the column's ability to produce well resolved or high and narrow chromatographic peaks. In some embodiments, the column is a polymer- or silica-based column where the stationary material comprises stationary material composed of a polymer or silica material, respectively.

The column may comprise a guard column and an analytical column. “Guard column” means a portion of the column that can scavenge debris or multivalent ions that would otherwise be accumulated within an analytical column. “Analytical column” means a portion of the column that effectively separates the analyte ions into resolvable chromatographic peaks. The guard column may comprise the same stationary phase material as the analytical column but other stationary phase materials may also be used.

“Effective separation temperature” means a temperature where the ionic analytes are resolvable. In some cases, the effective separation temperature may be between 25.0-55.0° C., including any temperature or temperature range therebetween.

“Suppressor” means a device for lowering background signal and increasing the useful signal. Because the eluent contains a relatively high amount of salt, the eluent contributes to background conductivity or signal. To differentiate between the background conductivity and signal from analyte, the suppressor reduces the amount of dissolved ions in the eluent. The suppressor may provide a suppressor solution. The suppressor solution may comprise an acid, such as H₂SO₄. In some embodiments, the suppressor includes a chemical suppressor and a CO₂ suppressor and the detector is a conductivity detector.

“Detector” means a device for detecting, identifying, or quantifying the analyte ions. Suitably the detector is a conductivity detector. A conductivity detector detects the conductivity of the eluate that passes through a cell comprising a multiplicity (e.g., 2 or 4) of electrodes between which an electrical potential is applied. When the sample ions pass through the cell, the conductivity is increased. This increase in current is proportional to the increase in conductivity, which is a function of the ion concentration.

“Data acquisition, storage, or processing device” means device for acquiring, storing, or processing signal output from the detector. Suitably the data acquisition, storage, or processing device is a computer or other suitable device.

An isocratic IC method is disclosed with suppressed conductivity detection for simultaneous quantification of bromide, phosphate, sulfite, thiosulfate, thiocyanate, formate, fluoride, chloride, chromate, selenate, perchlorate, nitrate, nitrite, and sulfate. Table 1 shows the quantification range, LOD, and LOQ for the analytes. The LOD of the analytes was in the range of 0.8-27.6 μg L⁻¹, and the LOQ was in the range of 2.9-92.1 μg L⁻¹ (Table 1). These data demonstrate the capability of the method to quantify trace concentrations of the analytes.

In some embodiments, the sample from the sample loop comprises a human origin sample or an environmental sample. In certain cases, the human origin sample comprises urine, feces, blood, or blood plasma.

Due to the capability of quantifying several anions simultaneously, the IC method developed in this study is useful to public health practitioners, medical professionals, diagnosticians, patients, environmental engineers, community stakeholders, academic and research organizations, and other industries that routinely measure co-occurring anions. An ion chromatograph equipped with a suppressed conductivity detector is a common instrumentation that many laboratories possess for quantification of common inorganic anions (e.g., Cl⁻, NO₃⁻, and SO₄²⁻) by EPA Method 9056A. Thus, the methods of the present disclosure can be adapted by laboratories that use the most common IC instrument. The Examples show that bromide, phosphate, sulfite, thiosulfate, thiocyanate, formate, fluoride, chloride, chromate, selenate, perchlorate, nitrate, nitrite, and sulfate in the low μg L⁻¹ concentration range can be measured without pre-treatment of the sample or post column derivatization. The IC method from this work was shown to be reliable, precise, accurate, and suitable for monitoring important anions in environmental aqueous media and human origin samples.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

Instrumentation

All analyses were performed using a Metrohm AG 930 compact IC flex system (Herisau, Switzerland). The IC system was equipped with a chemical suppressor (Metrohm Suppressor Module (MSM-II)) and a conductivity detector. An 800 dosino regeneration system was used to deliver the chemical suppressor solution to the MSM. The Metrohm CO₂ Suppressor (MC S) removed the carbonate (as CO₂) produced during the chemical suppression reaction in the MSM-II. The anions were separated using a Metrosep A Supp 7 analytical column (150 mm×4 mm, Metrohm) and a Metrosep A Supp 5 Guard column (5 mm×4 mm, Metrohm). A Metrohm 889 IC autosampler plus was used for sample injection. The volume of the sample injection loop was 100 μL. The data acquisition and processing were performed with the MagIC Net 3.3 Metrodata software.

Chemicals and Reagents

The eluent and the MSM suppressor solution were prepared using deionized and purified water using a PURELAB® Ultra (ELGA LabWater, United Kingdom) with a specific resistance ≥18.2 MΩ-cm. The eluent (mobile phase) contained 3.6 mM sodium carbonate (Na₂CO₃; 3% (v/v) of Metrohm's A Supp 7 eluent 100X concentrate), 4 mM sodium bicarbonate (NaHCO₃; Sigma-Aldrich), 8% (v/v) acetone (ACS reagent, Sigma-Aldrich), and 5% (v/v) methanol (CH₃OH; ACS reagent, Sigma-Aldrich) in deionized water. The MSM suppressor solution contained 500 mM H₂SO₄ in deionized water.

Analytical Methods

The IC method used a constant eluent flow rate of 0.8 mL min⁻¹ and a constant column/oven temperature of 55° C. The MSM stepping interval was 10 mins and the conductivity detector was set at 2.3% per ° C. At these conditions, the back pressure was 8.5±0.2 MPa. The pump start-up time was at 45 to 60 min during the equilibration of the instrument. A shorter pump start-up time may lead to column damage and/or system shutdown due to increase of the back pressure more than the maximum column pressure (15 MPa).

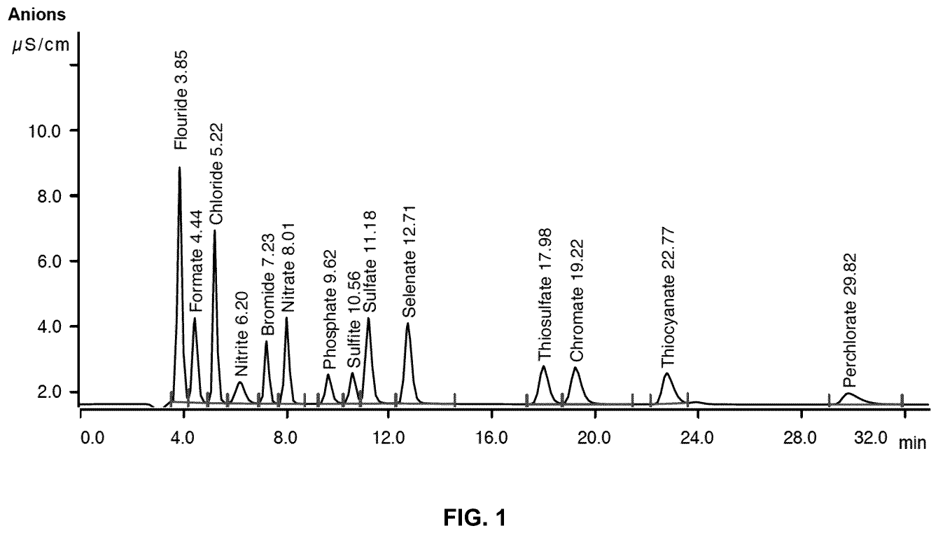

Table 1, included below, shows the detection parameters for each analyte measured using the method described in these Examples. Specifically, the detection limits of the anions using this method are in the low ug/L range of 0.8-27.6 μg/L, suggesting this method can be useful to measure in low-titer sample matrices. FIG. 1 shows a chromatogram of all 14 anions in water at 1 mg/L concentration.

Table 2 shows the analyte accuracy of quantification using the disclosed method at spiked concentration of 50, 500, and 900 μg/L.

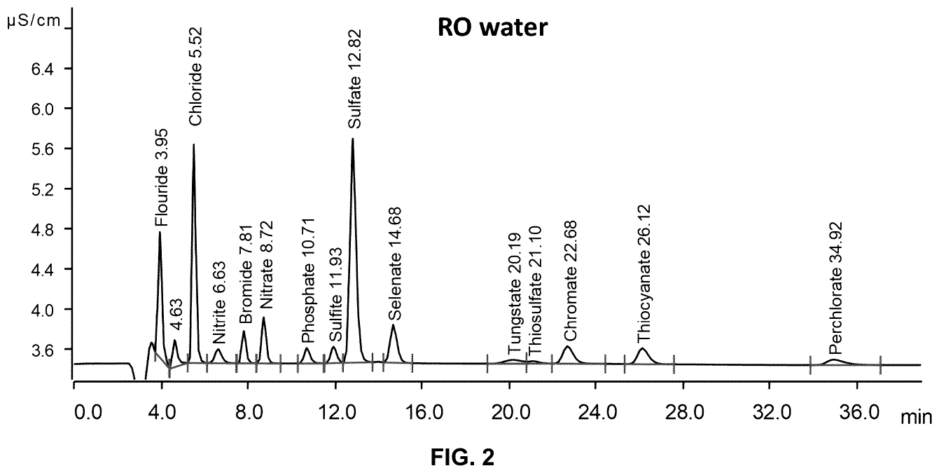

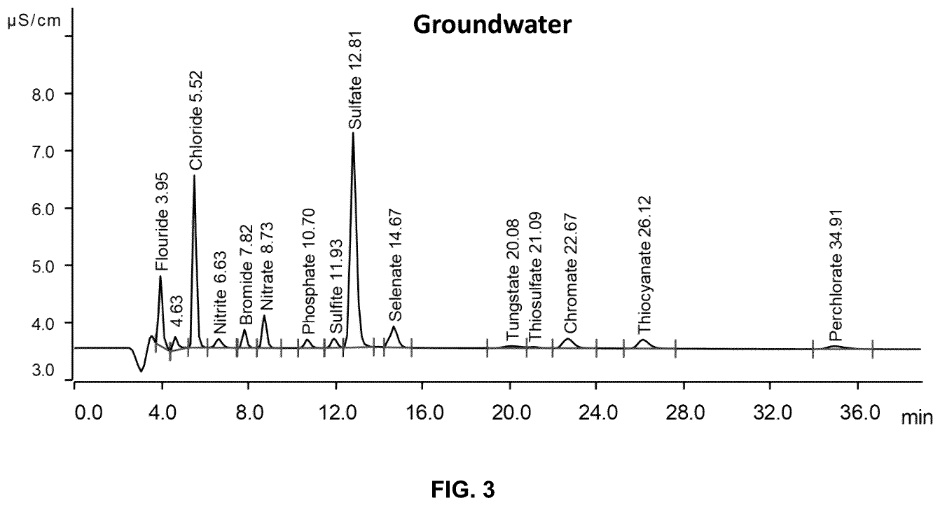

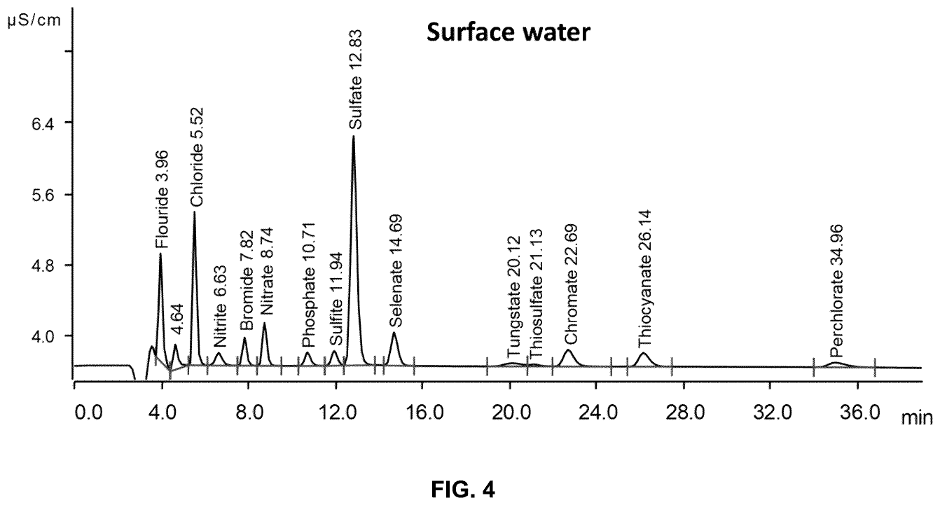

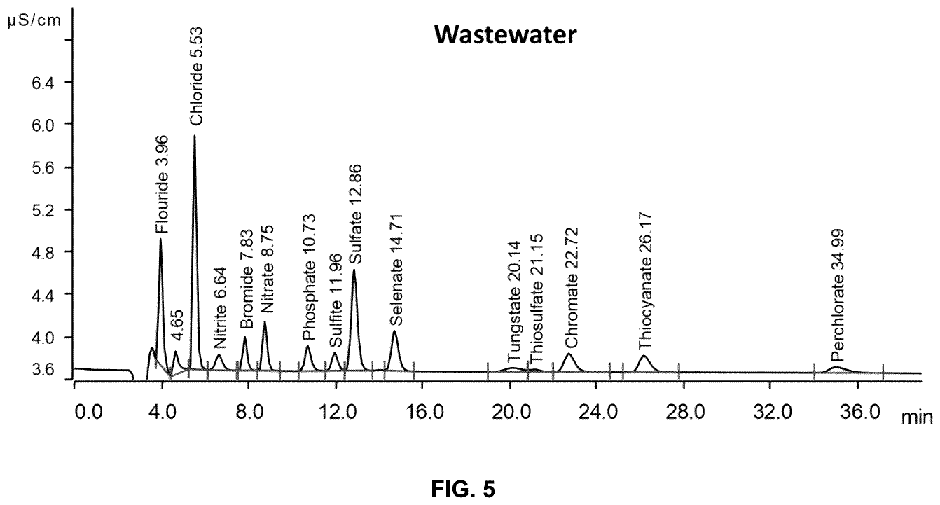

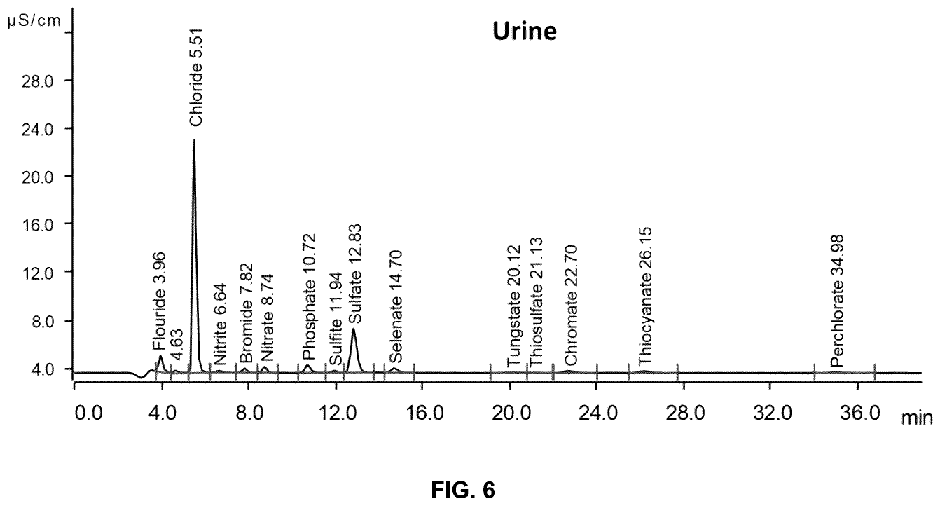

Table 3 shows recovery (%) of the anion analytes in several different environmental and human-origin sample matrices at spiked concentration of 200 and 800 μg/L. FIGS. 2-6 show a chromatograms of all 14 anions in several different environmental and human-origin sample matrices at spiked concentration of 200 μg/L

The method demonstrated good precision and accuracy in quantification of all the anion analytes in human origin (e.g., urine, feces, blood, or blood plasma) and environmental aqueous matrices.

Advantageously, this method can simultaneously detect multiple anions in a wide range of human and environmental origin matrices in a relatively short period of time per sample. Given the number of analytes detected per low-volume sample (such as less than 1 mL or even less than 500 μL), this method is also cost-effective and would be useful for a wide range of professionals working in the environmental and health/healthcare settings (e.g., environmental engineers, public health practitioners, medical professionals, diagnosticians, patients, and community stakeholders).

TABLE 1
Quantification range, LOD, and LOQ of 14 analytes
in deionized water using the method from this study.
(ClO₄⁻ was the last analyte in the method run).

| Elution | | Quantification | LOD | LOQ |
|---|---|---|---|---|
| order | Analyte | Range (μg L⁻¹) | (μg L⁻¹) | (μg L⁻¹) |
| 1 | F⁻ | 10.4-10,000 | 3.1 | 10.4 |
| 2 | CHO₂⁻ | 12.9-10,000 | 3.9 | 12.9 |
| 3 | Cl⁻ | 11.0-10,000 | 3.3 | 11.0 |
| 4 | NO₂⁻ | 12.7-10,000 | 3.8 | 12.7 |
| 5 | Br⁻ | 4.0-10,000 | 1.2 | 4.0 |
| 6 | NO₃⁻ | 92.1-10,000 | 27.6 | 92.1 |
| 7 | PO₄³⁻ | 12.8-10,000 | 3.8 | 12.8 |
| 8 | SO₃²⁻ | 3.6-10,000 | 1.1 | 3.6 |
| 9 | SO₄²⁻ | 8.0-10,000 | 2.4 | 8.0 |
| 10 | SeO₄²⁻ | 7.3-10,000 | 2.2 | 7.3 |
| 11 | S₂O₃²⁻ | 5.0-10,000 | 1.5 | 5.0 |
| 12 | CrO₄²⁻ | 2.9-10,000 | 0.8 | 2.9 |
| 13 | SCN⁻ | 3.5-10,000 | 1.1 | 3.5 |
| 14 | ClO₄⁻ | 16.8-10,000 | 5.1 | 16.8 |

TABLE 2
Analyte accuracy of quantification in deionized water using the disclosed method.

| | | | | | | Spiked | |
|---|---|---|---|---|---|---|---|
| | | Spiked concentration, | | Spiked concentration, | | concentration, | |
| | | 50 μg/L (n = 6) | | 500 μg/L (n = 6) | | 900 μg/L (n = 6) | |
| | | Precision | Trueness | Precision | Trueness | Precision | Trueness |
| Elution | | (RSD | (Recovery | (RSD | (Recovery | (RSD | (Recovery |
| order | Analyte | [%]) | [%]) | [%]) | [%]) | [%]) | [%]) |
| 1 | F⁻ | 0.5 | 113.0 | 0.2 | 97.7 | 0.4 | 100.8 |
| 2 | CHO₂⁻ | 12.6 | 105.6 | 1.4 | 97.9 | 0.4 | 97.1 |
| 3 | Cl⁻ | 0.0 | 107.6 | 5.9 | 98.8 | 5.8 | 101.0 |
| 4 | NO₂⁻ | 3.5 | 96.9 | 1.8 | 86.0 | 1.2 | 92.0 |
| 5 | Br⁻ | 0.0 | 104 | 0.0 | 91.4 | 0.4 | 92.6 |
| 6 | NO₃⁻ | NA | NA | 1.6 | 107.9 | 1.1 | 97.5 |
| 7 | PO₄³⁻ | 0.0 | 122 | 0.0 | 117.2 | 0.9 | 121.4 |
| 8 | SO₃²⁻ | 0.0 | 104.0 | 0.7 | 87.7 | 2.3 | 91.9 |
| 9 | SO₄²⁻ | NA | NA | 2.1 | 108.1 | 2.9 | 101.2 |
| 10 | SeO₄²⁻ | 1.1 | 126.5 | 0.2 | 102.5 | 0.5 | 104.7 |
| 11 | S₂O₃²⁻ | 0.0 | 95.6 | 0.5 | 94.0 | 0.4 | 95.9 |
| 12 | CrO₄²⁻ | 1.6 | 105.1 | 2.0 | 99.6 | 0.6 | 101.5 |
| 13 | SCN⁻ | 1.4 | 119.7 | 0.9 | 94.9 | 0.7 | 94.9 |
| 14 | ClO₄⁻ | 10.4 | 88.7 | 0.7 | 80.2 | 1.0 | 81.0 |

TABLE 3
Recovery (%) of all anion analytes in environmental and human-origin sample matrices. The data are averages with
standard deviation of triplicates. The spiking concentration for all anions was 200 μg L⁻¹ and 800 μg L⁻¹.

| | Spiked conc. | | | | | | | |
|---|---|---|---|---|---|---|---|---|
| Sample | (μg L⁻¹) | F⁻ | Cl⁻ | NO₂⁻ | Br⁻ | NO₃⁻ | PO₄³⁻ | SO₃²⁻ |
| RO water | 200 | 96.8 ± 1.2 | 99.6 ± 1.8 | 90.0 ± 3.3 | 90.0 ± 0.0 | 94.3 ± 2.3 | 85.4 ± 1.0 | 97.2 ± 1.0 |
| (Tempe, AZ) | 800 | 102.1 ± 0.2 | 100.5 ± 0.2 | 97.6 ± 2.5 | 91.3 ± 0.0 | 99.7 ± 0.5 | 82.5 ± 0.4 | 94.9 ± 0.2 |
| Groundwater | 200 | 95.4 ± 0.4 | 93.3 ± 2.0 | 90.6 ± 1.0 | 88.8 ± 1.2 | 93.3 ± 0.6 | 84.8 ± 0.0 | 84.4 ± 1.0 |
| (Goodyear, AZ) | 800 | 101.9 ± 0.4 | 101.3 ± 1.0 | 97.4 ± 1.7 | 91.0 ± 0.7 | 100.7 ± 0.7 | 82.7 ± 0.6 | 88.9 ± 0.9 |
| Surface water | 200 | 96.8 ± 0.8 | 91.7 ± 0.0 | 91.7 ± 2.9 | 88.8 ± 0.0 | 98.3 ± 0.6 | 86.5 ± 0.0 | 98.3 ± 0.0 |
| (Tamilnadu, India) | 800 | 102.2 ± 0.1 | 97.7 ± 0.3 | 95.1 ± 2.1 | 91.1 ± 0.2 | 101.0 ± 0.0 | 83.3 ± 0.0 | 96.8 ± 0.2 |
| Wastewater | 200 | 96.4 ± 1.1 | 98.0 ± 2.2 | 91.1 ± 2.5 | 90.4 ± 0.7 | 98.7 ± 0.6 | 78.2 ± 0.0 | 100.0 ± 0.0 |
| (Water | 800 | 102.1 ± 0.2 | 101.1 ± 0.6 | 94.0 ± 1.3 | 91.6 ± 0.0 | 101.0 ± 0.0 | 81.9 ± 0.2 | 97.2 ± 0.2 |
| reclamation | | | | | | | | |
| plant, Mesa) | | | | | | | | |
| Urine | 200 | 110.5 ± 0.6 | 114.4 ± 4.2 | 82.2 ± 3.5 | 87.9 ± 0.7 | 93.7 ± 1.2 | 71.5 ± 0.0 | 95.0 ± 0.0 |
| | 800 | 106.2 ± 0.3 | 115.1 ± 1.7 | 94.4 ± 1.3 | 91.1 ± 0.2 | 99.9 ± 0.3 | 81.8 ± 0.2 | 92.9 ± 0.4 |

| | Spiked conc. | | | | | | |
|---|---|---|---|---|---|---|---|
| Sample | (μg L⁻¹) | SO₄²⁻ | SeO₄²⁻ | S₂O₃²⁻ | CrO₄²⁻ | SCN⁻ | ClO₄⁻ |
| RO water | 200 | 97.5 ± 40.9 | 92.4 ± 0.4 | 91.0 ± 4.1 | 101.0 ± 1.5 | 96.2 ± 0.6 | 88.7 ± 1.7 |
| (Tempe, AZ) | 800 | 28.0 ± 2.1 | 91.8 ± 0.1 | 91.2 ± 2.7 | 100.1 ± 0.3 | 95.0 ± 0.0 | 88.6 ± 0.2 |
| Groundwater | 200 | 101.4 ± 50.5 | 91.4 ± 1.1 | 88.6 ± 0.0 | 99.6 ± 1.2 | 94.6 ± 0.6 | 87.0 ± 1.7 |
| (Goodyear, AZ) | 800 | 87.9 ± 13.9 | 91.8 ± 0.6 | 89.4 ± 2.7 | 100.1 ± 0.7 | 94.9 ± 0.6 | 88.8 ± 0.4 |
| Surface water | 200 | ND | 99.8 ± 0.4 | 81.4 ± 0.0 | 99.0 ± 0.0 | 95.2 ± 0.6 | 88.7 ± 0.0 |
| (Tamilnadu, India) | 800 | 115.7 ± 16.0 | 103.9 ± 0.2 | 87.0 ± 1.0 | 100.0 ± 0.0 | 94.9 ± 0.1 | 89.4 ± 0.5 |
| Wastewater | 200 | ND | 100.2 ± 0.4 | 86.2 ± 4.1 | 101.0 ± 0.6 | 95.9 ± 0.0 | 88.1 ± 1.9 |
| (Water | 800 | 99.9 ± 3.7 | 103.6 ± 0.3 | 87.6 ± 1.0 | 100.4 ± 0.1 | 95.1 ± 0.1 | 88.0 ± 0.7 |
| reclamation | | | | | | | |
| plant, Mesa) | | | | | | | |
| Urine | 200 | ND | 98.8 ± 0.8 | 88.6 ± 0.0 | 99.3 ± 0.0 | 94.9 ± 0.0 | 86.4 ± 1.0 |
| | 800 | 129.7 ± 28.5 | 103.2 ± 0.4 | 90.6 ± 1.0 | 99.3 ± 0.0 | 94.6 ± 0.1 | 88.0 ± 0.0 |

ND = Not determined.

We claim:

1. A method for simultaneous quantification of anions, the method comprising loading a sample loop with an aqueous sample;
injecting the sample from the sample loop into a column with an eluent, wherein the column comprises a guard column and an analytical column;
separating, with the column, the injected sample at an effective separation temperature in the presence of an organic modifier into a multiplicity of detectable ionic analytes comprising bromide, phosphate, sulfite, thiosulfate, thiocyanate, and formate;
suppressing, with a suppressor, background signal; and
detecting, with a detector, the multiplicity of ionic analytes.

2. The method of claim 1, wherein the multiplicity of detectable ionic analytes comprises bromide, phosphate, sulfite, thiosulfate, thiocyanate, formate, fluoride, chloride, chromate, selenate, perchlorate, nitrate, nitrite, and sulfate, and the detectable ionic analytes are simultaneously detected.

3. The method of claim 1, wherein the sample from the sample loop comprises a human origin sample or an environmental sample.

4. The method of claim 1, wherein the sample from the sample loop comprises a human origin sample comprising urine, feces, blood, or blood plasma.

5. The method of claim 1, wherein the organic modifier comprises acetone and methanol.

6. The method of claim 1, wherein the eluent comprises sodium carbonate and sodium bicarbonate.

7. The method of claim 1, wherein a volume of the sample from the sample loop is less than 500 μL.

8. The method of claim 1, wherein the suppressor comprises a chemical suppressor and a CO₂ suppressor and the detector is a conductivity detector.

9. The method of claim 1, wherein the eluent comprises sodium carbonate and sodium bicarbonate, the organic modifier comprises acetone and methanol, and the multiplicity of detectable ionic analytes comprises bromide, phosphate, sulfite, thiosulfate, thiocyanate, formate, fluoride, chloride, chromate, selenate, perchlorate, nitrate, nitrite, and sulfate, and the multiplicity of detectable ionic analytes are simultaneously detected.

10. The method of claim 9, wherein the limit of detection (LOD) of the multiplicity of detectable ionic analytes is in a range between 0.8 and 27.6 μL⁻¹.

11. A system for simultaneous quantification of anions, the system comprising
an eluent;
an organic modifier;
an injector;
a column, the column comprising a guard column and an analytical column;
a suppressor; and
a detector,
wherein the injector is configured to inject an aqueous sample from a sample loop into the column with the eluent, the column is configured to separate the injected sample in the presence of the organic modifier into a multiplicity of detectable ionic analytes comprising bromide, phosphate, sulfite, thiosulfate, thiocyanate, and formate at an effective separation temperature, the suppressor is configured to suppress a background signal, and the detector is configured for detection of the multiplicity of ionic analytes.

12. The system of claim 11, wherein the system is configured for simultaneous detection of bromide, phosphate, sulfite, thiosulfate, thiocyanate, formate, fluoride, chloride, chromate, selenate, perchlorate, nitrate, nitrite, and sulfate.

13. The system of claim 11, wherein the sample from the sample loop comprises a human origin sample or an environmental sample.

14. The system of claim 11, wherein the sample from the sample loop comprises a human origin sample comprising urine, feces, blood, or blood plasma.

15. The system of claim 11, wherein the organic modifier comprises acetone and methanol.

16. The system of claim 11, wherein the eluent comprises sodium carbonate and sodium bicarbonate.

17. The system of claim 11, wherein a volume of the sample from the sample loop is less than 500 μL.

18. The system of claim 11, wherein the suppressor comprises a chemical suppressor and a CO₂ suppressor and the detector is a conductivity detector.

19. The system of claim 11, wherein the eluent comprises sodium carbonate and sodium bicarbonate, the organic modifier comprises acetone and methanol, and the system is configured for simultaneous detection of bromide, phosphate, sulfite, thiosulfate, thiocyanate, formate, fluoride, chloride, chromate, selenate, perchlorate, nitrate, nitrite, and sulfate.

20. The system of claim 19, wherein the limit of detection (LOD) of the multiplicity of ionic analytes is in a range between 0.8 and 27.6 μL⁻¹.
